(19) United States
(12) Patent Application Publication
(10) Pub. No.: US 2021/0318743 A1
(43) Pub. Date: Oct. 14, 2021

(54) SENSING AUDIO INFORMATION AND FOOTSTEPS TO CONTROL POWER

(71) Applicant: Hewlett-Packard Development Company, L.P., Spring, TX (US)

(72) Inventors: Suketu Partiwala, Palo Alto, CA (US); Sunil Bharitkar, Palo Alto, CA (US); Madhu Athreya, Palo Alto, CA (US); William Allen, Corvallis, OR (US)

(73) Assignee: Hewlett-Packard Development Company, L.P., Spring, TX (US)

(21) Appl. No.: 17/273,328

(22) PCT Filed: Dec. 3, 2018
(86) PCT No.: PCT/US2018/063599

§ 371 Date: Mar. 4, 2021

(51) Int. Cl. G06F 1/3231; H04R 1/08; G06N 20/00; G01S 17/04

(52) U.S. Cl. CPC G06F 1/3231; H04R 1/08; H04W 4/80; G01S 17/04; G06N 20/00

(57) ABSTRACT

A method, according to one example, includes sensing audio information with an audio microphone of a computing device. The method includes determining, by a controller of the computing device, whether the sensed audio information indicates footsteps moving toward the computing device. The method includes causing, by the controller, a powering up of a presence sensor having a higher power consumption than the microphone in response to a determination by the controller that the sensed audio information indicates footsteps moving toward the computing device.

### BACKGROUND

Operating systems of computing devices may provide power management features. For example, timer-based features may be used to provide power savings. If user activity is absent for more than what the idle timer threshold is, the system starts saving power by going into lower power states. The power saving starts when the idle timer threshold is reached.

### BRIEF DESCRIPTION OF THE DRAWINGS

FIG. 1 is a block diagram illustrating a computing device with user presence detection capabilities according to one example.

FIG. 2 is a block diagram illustrating presence sensors of the computing device shown in FIG. 1 according to one example.

FIG. 3 is a flow diagram illustrating a footstep detection method according to one example.

FIG. 4 is a flow diagram illustrating a method of detecting the presence of a user and controlling the power state of a computing device according to one example.

FIG. 5 is a flow diagram illustrating a method of using audio information for power control of a computing device according to one example.

FIG. 6 is a block diagram illustrating a system that uses audio information for power control of a computing device according to one example.

FIG. 7 is a flow diagram illustrating a method of using audio information for power control of a computing device according to another example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

For any computing device, it is helpful to determine if the device is actively being used. This indication can help the device determine the power state and to set security policies. For instance, if the user has walked away from the device, locking the device could thwart an intruder from snooping. Furthermore, the device may transition itself into a low power standby state to conserve battery energy. Computing devices may rely on user interaction (e.g., via keyboard or mouse clicks) and an idle timer to determine active usage of the device. If there is no activity for an extended amount of time, a decision is made about the user not being present, and actions may be taken to increase security and power efficiency. However this method can be inaccurate. For example, the method may incorrectly determine that the user is not present when the user is reading a document on the device or using an audio call feature without interacting with the keyboard and/or mouse. Such inaccurate presence determinations may result in frustrating user experiences, potential security hazards, and wasting of battery energy.

For timer-based power saving features of computing devices, the power saving starts when the idle timer threshold is reached. In cases where the user comes back to the normal activity right after the idle timer threshold is reached, the savings is minimal. This approach of relying on timer-based features may work when the user is idle for an extended period, but this approach is flawed as the device may still be wasting power during the period where the idle timer threshold timer is not reached. This power could be saved by detecting the user walking away from the computing device.

A computing device could rely solely on an RGB camera or an IR camera of the device to detect user presence and transition the device into a lower power state when no presence is detected. However, users may mask OFF the cameras for privacy reasons, which prevents the ability to use the camera for presence detection. Camera sensors also typically consume relatively large amounts of power, so the overall energy saved is negatively impacted. In addition, methods to process data collected from such camera sensors typically run on the CPU, but the CPU itself is typically powered OFF in low power standby states. Hence, this approach can be used to transition the device into a low power state, but may not be available to seamlessly wake the device when the user walks back.

To enable some computing devices from a standby state, a user may be expected to physically touch a keyboard key or click the mouse, and then wait for the system to power-ON and complete a manual login process. This process is inefficient and time consuming for the user.

Some examples of the present disclosure are directed to a computing device that detects a user walking away from the device and immediately transitions the device to an inoperable condition until user authentication is performed. In some examples, the computing device uses an ordered list of sensors to accurately detect the presence of a user in the vicinity of the computing device and the user's intentions before changing the security levels and power states of the device. This increases the security and power efficiency of the computing device. The sensors are ordered based on power consumption. The sensors with higher power consumption are generally more accurate than the lower power consumption sensors. The lower power sensors are used first, and if presence of the user is detected, the device triggers the use of higher power sensors for more accurate detection. This process continues through the ordered list until a final determination is made to power up the device and trigger an authentication process. One example uses a microphone as one of the lower power sensors to detect footsteps and determine if the footsteps are moving toward the electronic device, and activate higher power sensors in response to the detection.

The authentication process may be an automatic process that does not require manual user interaction, such as one that uses facial recognition, to automatically authenticate the user. Some examples detect the user walking back to the device, which triggers the device to start warming up or powering ON. A facial recognition authentication process may then be automatically performed as soon as the user is positioned in front of the device to seamlessly log the user back into the device. This may be a seamless user experience, where the user is unaware of the fact that the device has transitioned into a standby state while the user was gone. Examples disclosed herein provide energy savings when the user is idle, increase security by locking the device while the user is away, and allow the user to seamlessly access the device when the user returns, thereby providing the experience to the user that nothing happened while the user was away.

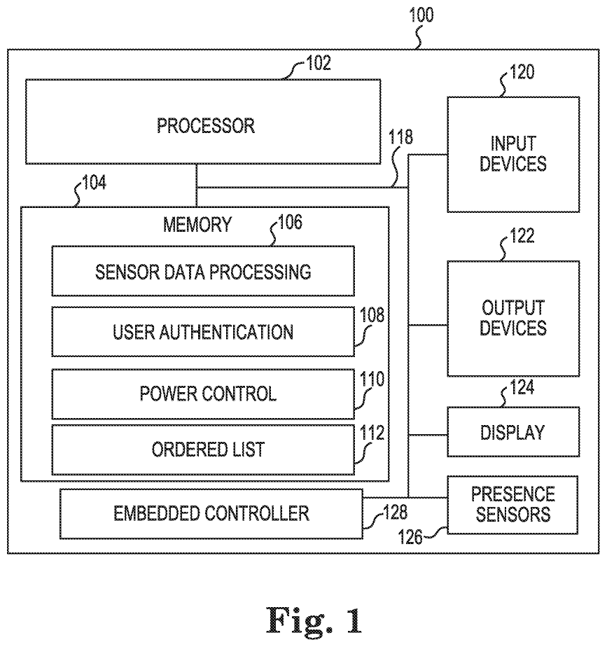

FIG. 1 is a block diagram illustrating a computing device 100 with user presence detection capabilities according to one example. Computing device 100 includes at least one processor 102, a memory 104, input devices 120, output devices 122, display 124, presence sensors 126, and embedded controller 128, which are communicatively coupled to each other through at least one communication link 118.

Input devices 120 include a keyboard, mouse, data ports, and/or other suitable devices for inputting information into device 100, and some of the input devices 120 may also be considered to be part of the presence sensors 126. Output devices 122 include speakers, data ports, and/or other suitable devices for outputting information from device 100.

Processor 102 includes a Central Processing Unit (CPU) or another suitable processor. In one example, memory 104 stores machine readable instructions executed by processor 102 for operating device 100. Memory 104 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 104 is non-transitory in the sense that it does not encompass a transitory signal but instead is made up of at least one memory component to store machine executable instructions for performing techniques described herein.

Memory 104 stores sensor data processing module 106, user authentication module 108, power control module 110, and ordered list 112. Processor 102 executes instructions of modules 106, 108, and 110 to perform techniques described herein. It is noted that some or all of the functionality of modules 106, 108, and 110 may be implemented using cloud computing resources.

Ordered list 112 is a list or schedule of sensors or “sensing capabilities” in a particular order. A “sensing capability” as used herein includes at least one physical sensor plus associated processing methods and the computing hardware on which those methods are executed. There is a general correlation between the quality/value of sensed information and the power consumed. The ordered list 112 is ordered such that one end includes lower powered/lower capability sensing capabilities and the other end includes sensing capabilities consuming more power but also having greater capabilities.

Computing device 100 uses the ordered list 112 to identify which sensing capabilities, and correspondingly which presence sensors 126, to use at any given time. In one example, computing device 100 operates solely the lowest power sensing capabilities (e.g., a single low power sensor 126 or a small set of low power sensors 126) when device 100 is asleep or in a not-in-use-at-this-moment mode. If the presence sensing capability of the device 100 indicates a user is possibly present (or nearby) with likely intent to use the device 100, then the device 100 sequentially and progressively activates higher power sensing capabilities in the ordered list 112. The device 100 progressively activates more power-hungry sensing capabilities in this manner to improve the estimation of the position and intent of the user. Sensor data processing module 106 may be used to receive sensor data from the activated presence sensors 126, process the received sensor data to make determinations about user presence and user intent, and activate and deactivate particular ones of the presence sensors 126.

If the estimation of user intent crosses a threshold, the device 100 is turned on completely, and becomes ready to interact with the user for identification and authentication. On the other hand, if the estimation of user intent does not cross the threshold, then, over time, the device 100 works backwards down the ordered list 112, powering down the more power-hungry sensing capabilities and moving the device 100 back toward a deeper sleep. Power control module 110 may be used to control the power state of device 100 based on presence detection determinations made by sensor data processing module 106. User authentication module 108 may be used to control the authentication of a user.

In general, the presence detection performed by computing device 100 can be partitioned into three aspects:

(1) Sensing Capabilities: Computing device 100 may employ many available sensors 126 to attain the maximum accuracy and power savings. Note that the set of sensors 126 employed and the number of stages (states) in the activation schedule defined by ordered list 112 are engineering variables that may be selected and optimized for any given implementation.

(2) Sensing Methods: The ordered list 112 for using the sensors 126 may be structured such that, over time, the device 100 uses less power. Initially, device 100 may sense at a higher frequency and consume higher power, but as the idleness of the user increases, device 100 may reduce the sensing frequency to reduce the power spent in sensing. Similarly, device 100 may use different sets of sensors and/or methods based on whether the device 100 is ON versus being in a sleep state. When the device 100 is ON, the device 100 has access to more compute power and can focus on higher accuracy, but while in standby mode, the processor 102 of device 100 may be OFF, and the device 100 may rely on very low power sensing capabilities.

(3) Overall Control: This aspect deals with identifying which sensors 126 to employ and when to employ those sensors 126, and also coordinating data gathered from multiple sensors 126 to make an accurate prediction of user presence and intent.

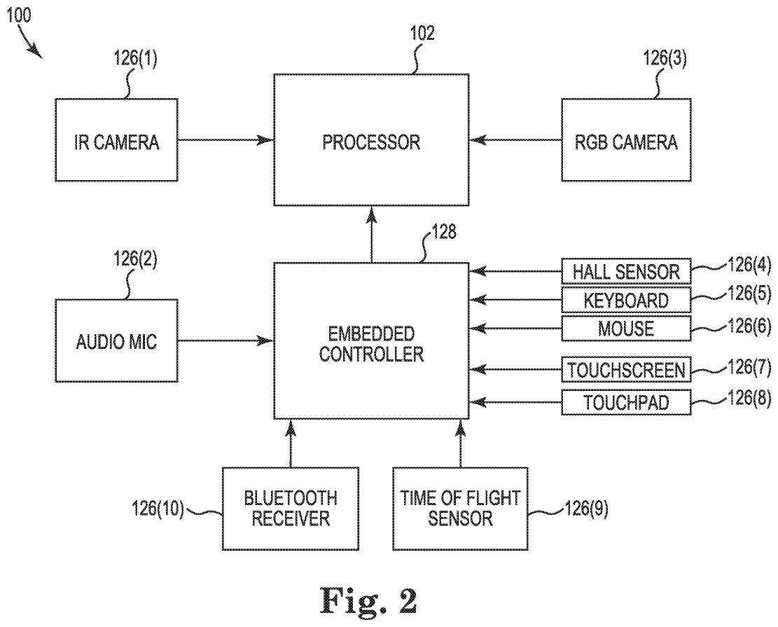

Each of these three aspects will now be described in further detail. Regarding the sensing capabilities aspect, computing device 100 may rely on numerous sensors 126 to accurately determine the presence of the user. Note that not all computing devices will use all of the sensors described herein, but the methods described herein exploit the available sensors on a given device to improve the accuracy of predictions. The sensing capabilities aspect is described in further detail below with additional reference to FIG. 2.

FIG. 2 is a block diagram illustrating presence sensors 126(1)-126(10) (collectively referred to herein as presence sensors 126) of the computing device 100 shown in FIG. 1 according to one example. The presence sensors 126 include infrared (IR) camera 126(1), audio microphone (MIC) 126(2), Red-Green-Blue (RGB) camera 126(3), Hall sensor 126(4), keyboard 126(5), mouse 126(6), touchscreen 126(7), touchpad 126(8), time of flight (ToF) sensor 126(9), and Bluetooth receiver 126(10). As shown in FIG. 2, a first subset of the presence sensors 126 are coupled to and communicate with the processor 102, and a second subset of the presence sensors 126 are coupled to and communicate with the embedded controller 128. Specifically, in the illustrated example, IR camera 126(1) and RGB camera 126(3) are coupled to and communicate with the processor 102; and audio microphone 126(2), Hall sensor 126(4), keyboard 126(5), mouse 126(6), touchscreen 126(7), touchpad 126(8), ToF sensor 126(9), and Bluetooth receiver 126(10) are coupled to and communicate with the embedded controller 128.

Hall sensor 126(4) is a transducer sensor based on detecting the Hall Effect due to magnetic field. In one example, the Hall sensor 126(4) is used by computing device 100 to detect whether the lid of the device 100 is closed or open on implementations of device 100 that have a clamshell structure. A closed lid usually means that the user is not actively using the system, and computing device 100 uses this information to transition the device 100 into a lower power state and increase the security level. Hall sensors are very power efficient and typically consume about 200 uw at 1 Hz operation.

Any activity detected by keyboard 126(5), mouse 126(6), touchscreen 126(7), and touchpad 126(8) suggests active usage by the user, and computing device 100 does not arm any other sensor 126 or modify the power state during active usage.

Bluetooth receiver 126(10) may be paired with a personal device of the user, such as a smartphone, tablet, smartwatch, fitness device, or an enterprise badge. Bluetooth receiver 126(10) may also be paired with many other kinds of Bluetooth devices (e.g., a Bluetooth door sensor in the room/office can provide an indication of when the user is entering the room where the user's device is located). Such Bluetooth devices can provide relative distance of the user from the computing device 100. Embedded controller 128 uses the Bluetooth information to determine the presence of the user. Embedded controller 128 can also determine whether the user is walking towards or away from the device 100 by looking at the difference between two Bluetooth readings spaced in time. This information aids the decision making by device 100 in aggressively transitioning the device 100 into a lower power state while the user is walking away, or warming the device 100 by transitioning the device 100 into higher power modes when the user walks towards the device 100.

ToF sensor 126(9) emits a laser or light pulse and measures distance based on when it receives the reflection back. ToF sensors are quite small in size and may be used to accurately detect the presence of a user. In addition to providing user detection, ToF sensor 126(9) may be used to accurately determine the distance of the user from the device 100. ToF sensor 126(9) may report a presence detection Boolean value and a distance value to embedded controller 128 at a predefined time interval. ToF sensors typically consume about 5 mW which is quite power efficient when compared to cameras.

Audio microphone 126(2) is used by embedded controller 128 to accurately detect footsteps and estimate the presence of the user in the vicinity of the device 100.

RGB camera 126(3) is a user-facing camera that may be used by computing device 100 to detect a user. RGB camera 126(3) may have a higher cost in terms of power than other sensors 126, so computing device 100 may use this sensor 126(3) as a last option, or when other sensors 126 are not available. The image processing for images provided by RGB camera 126(3), and the determination of user presence based on this image processing, may be performed by processor 102, so RGB camera 126(3) may not be available when the processor 102 is in a standby state. RGB cameras typically have a higher power consumption (e.g., about 1.2 W).

IR camera 126(1) may be the most accurate of the sensors 126, but may also be the most expensive in terms of power and financial cost. In one example, computing device 100 does not use IR camera 126(1) for presence detection, but rather uses it to authenticate the user and log the user back into the device 100. Processor 102 may be used to process the raw data from IR camera 126(1), so IR camera 126(1) may not be available when the processor 102 is in a standby state.

As mentioned above, the second aspect of the presence detection performed by computing device 100 is sensing methods. These sensing methods include a footstep detection method, which uses the audio microphone 126(2). While the computing device 100 is in a standby mode, the device 100 may use the footstep detection method to detect footsteps and determine if the user is walking towards the device 100.

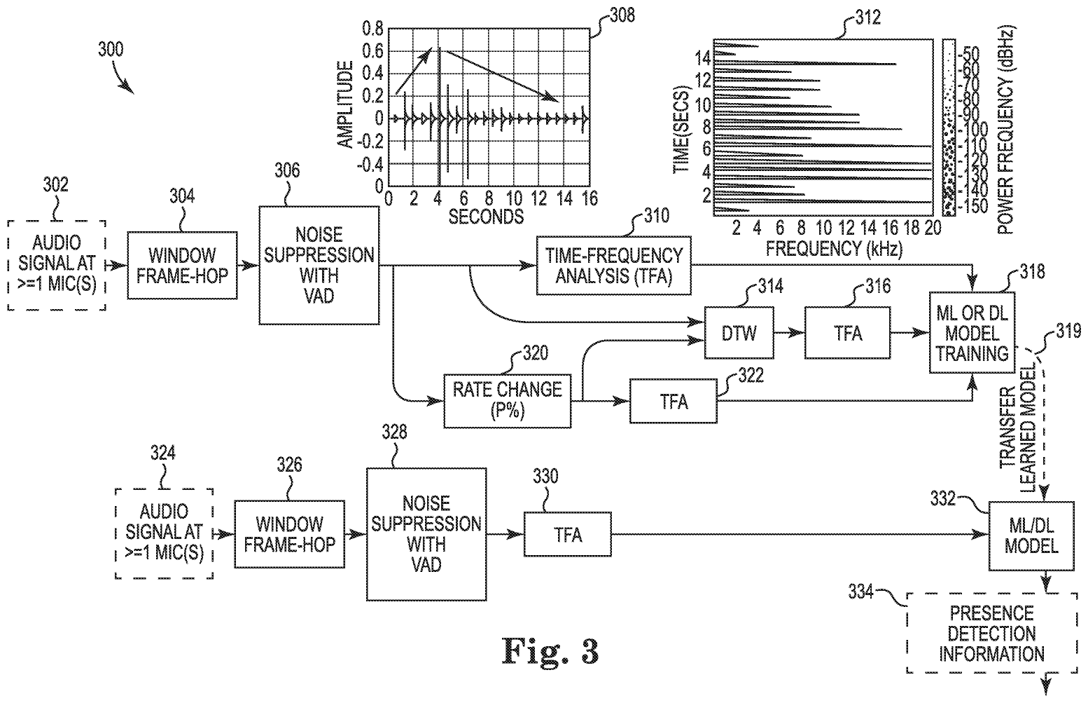

FIG. 3 is a flow diagram illustrating a footstep detection method 300 according to one example. In one example, embedded controller 128 (FIG. 2) performs method 300 to detect arriving and departing footsteps relative to the position of at least one audio microphone 126(2). At 304 in method 300, an audio signal 302 from at least one audio microphone 126(2) is received, and a window frame-hop process is performed, which involves framing the received audio signal 302 for a frame by frame analysis. Each audio frame may include, for example, 512 or 1024 samples. A frame may be a window of size 512 samples, and a hop of 256 could be used to hop from one window to another, implying overlapping data between the two frames of audio. At 306, noise suppression with voice activity detection (VAD) is performed on received audio frames. The noise suppression performed at 306 includes suppressing ambient noise to eliminate stationary noise (e.g., HVAC ambient noise). The footstep audio information is distinct from the stationary noise, and remains intact after the noise suppression. In one example, the noise suppression performed at 306 uses a spectral subtraction technique. If there is speech mixed in with noise, the noise may be impulsive or non-stationary, and the performance of the noise suppression may be affected. In such cases, VAD may be used to provide additional information for detecting user presence.

Graph 308 represents the audio information after the noise suppression is performed at 306. The horizontal axis in graph 308 represents time, and the vertical axis represents the linear amplitude of the audio information. The graph 308 also identifies a first portion of the audio signal that indicates approaching footsteps, and a second portion of the audio signal that indicates receding footsteps.

At 310, a time-frequency analysis (TFA) is performed on the audio information generated at 306 to generate a time-frequency map (spectrogram) 312. Before training a deep learning (DL) model to identify approaching or departing footsteps, the time-frequency map 312 is synthesized using a short-time Fourier transform that extracts temporal-spectral information of footsteps. At 318, the time-frequency map 312 is used (along with other information) to train a machine learning (ML) or DL model.

At 314, dynamic time warping (DTW) is performed on the audio information generated at 306 to generate warped audio information. At 316, TFA is performed on the warped audio information to generate additional time-frequency map data that is used at 318 to train the ML or DL model.

At 320, rate changes (e.g., p%, which may be any positive or negative percentage value) are applied to the audio information generated at 306 to generate rate changed audio information. In one example, positive “p” values represent time dilation (i.e., slower footsteps), and negative “p” values represent time compression (i.e., faster footsteps). At 316, TFA is performed on the rate changed audio information to generate additional time-frequency map data that is used at 318 to train the ML or DL model. By performing the DTW at 314 and the rate changes at 320, the amount of data available to train the ML or DL model is increased, and the data includes variations in the time information, which results in a more robust model.

The training performed at 318 may be performed on a large corpus of footsteps on a variety of acoustics materials (e.g., carpets, cement floor, etc.) in the presence or absence of room reflections. Additionally, room models may be used to synthesize synthetic room-reflected footsteps as augmentation schemes. Additionally, given that footsteps have arbitrary pacing/cadence (e.g., fast, running, slow), the model can include synthetic rates of footsteps employing phase-vocoding techniques. Techniques from ML methods (e.g., using onset, envelope of footsteps, intensity cues, etc.) can be extracted from the time-frequency map 312 to train a ML model to classify between approaching or receding footsteps. Another example may use DL approaches involving convolutional neural networks (CNN) directly from the time-frequency map 312.

After the ML or DL model has been trained at 318, the trained model 332 is transferred, as indicated by arrow 319, to an operational environment to perform inferencing. The inferencing process begins at 326 where an audio signal 324 is received, and a window frame-hop process is performed, which involves framing the received audio signal 324 for a frame by frame analysis. Each audio frame may include, for example, 512 or 1024 samples. At 328, noise suppression with VAD is performed on received audio frames. The noise suppression performed at 328 includes suppressing ambient noise to eliminate stationary noise (e.g., HVAC ambient noise). In one example, the noise suppression performed at 328 uses a spectral subtraction technique.

At 330, TFA is performed on the audio information generated at 328 to generate a time-frequency map. The time-frequency map is synthesized using a short-time Fourier transform that extracts temporal-spectral information of footsteps. The time-frequency map is provided to the trained model 332 to perform inferencing, and then output presence detection information 334, which includes information indicating whether footsteps are approaching or departing.

As mentioned above, the third aspect of the presence detection performed by computing device 100 is overall control. Not all sensors described herein will be available on every device. Also, each type of sensor may have different characteristics in terms of accuracy and power. For example, RGB camera 126(3) may be very accurate, but may also consume a relatively large amount of power. Not all sensors 126 are stand-alone sensors that have the ability to work when the computing device 100 is in a low-power and/or a standby state. For example, if the processor 102 is not running, the RGB camera 126(3) may not be available for presence detection, whereas the ToF sensor 126(9) may be available even when the processor 102 is not running. Some examples disclosed herein exploit all of the available sensors on a given device and attempt to optimize the presence detection for low power and a positive user experience.

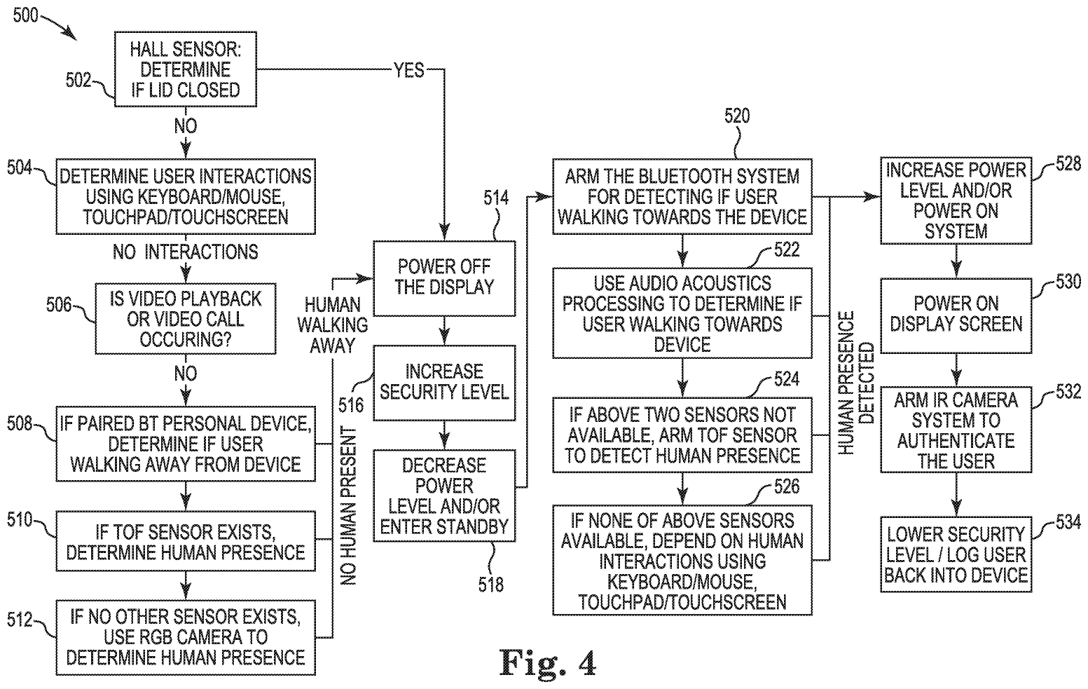

FIG. 4 is a flow diagram illustrating a method 500 of detecting the presence of a user and controlling the power state of a computing device according to one example. In one example, computing device 100 performs method 500. At 502 in method 500, the Hall sensor 126(4) is used by embedded controller 128 to determine whether the lid of the computing device 100 is closed. If it is determined at 502 that the lid of the computing device 100 is closed, the method 500 moves to 514. If it is determined at 502 that the lid of the computing device 100 is not closed, the method 500 moves to 504. Assuming that the device 100 is not being docked or connected to an external keyboard/mouse, closing the lid of the device 100 is a good indication of it not being actively used by the user. Thus, closing the lid may be used as an indication to immediately start transitioning the device 100 into a lower power state.

At 504, embedded controller 128 determines whether there has been any user interaction with the keyboard 126(5), mouse 126(6), touchscreen 126(7), or touchpad 126(8). If it is determined at 504 that there has been user interaction with any of these elements, the embedded controller 128 continues to monitor these elements until a period of no user interaction is identified. If it is determined at 504 that there has been no user interaction with any of these elements, the method 500 moves to 506. In one example, embedded controller 128 uses a programmable counter, set to, for example, 5 seconds, which is reset every time an activity on one of these elements is detected. If no activity is detected for the programmed amount of time, embedded controller 128 concludes that the user is not actively interacting with the device 100.

At 506, computing device 100 determines whether video playback or a video call is occurring (i.e., the user may be watching a video or participating in a video call). Such usages may result in no activity on the keyboard 126(5), mouse 126(6), touchscreen 126(7), or touchpad 126(8), but the device 100 is not powered down since the user is using it. If it is determined at 506 that there is no video playback or a video call occurring, the method 500 moves to 508.

At 508, if the user has a Bluetooth (BT) personal device (e.g., smartphone, smartwatch, fitness device, or corporate badge) paired with the Bluetooth receiver 126(10) of the computing device 100, the embedded controller 128 determines whether the user is walking away from the device 100 based on Bluetooth information received from the user's BT personal device. Embedded controller 128 can determine the relative distance between the device 100 and the user (assuming the user is carrying the personal BT device). Embedded controller 128 uses the strength of the Bluetooth signal to estimate the relative distance of the user from the device 100. Embedded controller 128 may estimate whether the user is walking away from the device 100 by comparing distances measured in two consecutive readings. If it is determined that the user is walking away from the device 100, the device 100 can immediately start taking actions to enter lower power modes. If it is determined at 508 that the user is walking away from the device 100, the method 500 moves to 514. If it is determined at 508 that the user is not walking away from the device 100, the method 500 moves to 510.

At 510, if the computing device 100 includes a ToF sensor 126(9), the embedded controller 128 uses the ToF sensor 126(9) to determine if the user is present near the device 100. ToF sensors are accurate up to about 2 meters and can provide an accurate determination of whether the user is present within the field of view of the sensor. A ToF sensor typically consumes about 5 mW for polling at every second, which is relatively power efficient. Embedded controller 128 may use multiple readings from ToF sensor 126(9) to increase the accuracy of detection, and to filter out stationary objects (e.g., a chair) versus a real human. If embedded controller 128 determines that the user is present, but is not being interactive, embedded controller 128 may keep polling the ToF sensor 126(9) in this mode to wait for the user to walk away. If it is determined at 510 that the user is not present near the device 100, the method 500 moves to 514. If it is determined at 510 that the user is present near the device 100, the method 500 moves to 512.

At 512, if computing device 100 does not include any additional presence sensors 126, the computing device 100 uses the RGB camera 126(3) to determine if the user is present near the device 100. Computing device 100 may also use the RGB camera 126(3) for presence detection if there is a low degree of confidence in a presence detection determination made based on other sensors 126. In one example, processor 102 uses a computer vision method to detect a human face in front of the device 100. Note that at this point in the method 500, computing device 100 is interested in detecting a human face, and not yet authenticating the user. Employing the RGB camera 126(3) for this purpose is relatively expensive from a power perspective, including the power consumed by the processor 102 to process images, so the RGB camera 126(3) may be used as a final option. If it is determined at 512 that the user is not present near the device 100, the method 500 moves to 514.

At 514, the computing device 100 powers off the display 124. Based on the data from sensors 126, computing device 100 may start taking actions towards transitioning the device 100 to a lower power state. Based on the confidence level in a presence determination, computing device 100 may immediately power off, or power down in smaller steps until a higher confidence level is reached. For example, assuming in a first snapshot taken by the ToF sensor 126(9) that the embedded controller 128 does not find any user presence, but the user could be just out of range of the ToF sensor 126(9) and might walk back to the device 100 in the next second. In such a situation, instead of completely powering off the device 100, device 100 may take a less aggressive step of slightly lowering the screen brightness. In the next snapshot taken by the ToF sensor 126(9), if user presence is still not detected, then computing device 100 may further dim the display 124. This process may continue until the device 100 has a high confidence that the user is not present and does not intend to immediately return, at which point the device 100 may more aggressively reduce power. On the other hand, if human presence is detected in any of the steps of method 500, the device 100 may revert back to full brightness and reset the method 500 to an initial state.

At 516, computing device 100 increases its security level and locks itself so that a user authentication process will be triggered the next time the user accesses the device 100. At 518, computing device 100 decreases the power level of the device 100 and puts itself into a lower power state and/or causes the device 100 to enter a very low power standby state. Note that a subset of the sensors 126 may still be operational in the standby state to detect user presence.

At 520, embedded controller 128 arms the Bluetooth system, including Bluetooth receiver 126(10), to detect if a user is walking towards the device 100 based on a paired personal device of the user. Information from the paired personal device may be used by embedded controller 128 to determine the relative distance of the user from the device 100 while the device 100 is in the standby state. When the user starts walking towards the computing device 100 while carrying the paired personal device, computing device 100 is able to detect the user approaching, which gives the computing device 100 an early indication to start powering ON or warming the device 100.

At 522, embedded controller 128 receives audio signals from audio microphone 126(2) and performs audio acoustics processing to determine if a user is walking towards the device 100. In one example, the embedded controller 128 detects footsteps and the direction of travel of the footsteps from the received audio signals, which can provide an early indication to the computing device 100 to start powering ON or warming the device 100.

At 524, if the Bluetooth receiver 126(10) and the audio microphone 126(2) are not available for user presence detection, the embedded controller 128 arms the ToF sensor 126(9) for user presence detection. Thus, after 520, 522, and 524, at least one of the lower power presence sensors 126 is enabled to operate during the low power state of the computing device 100 to detect the user coming back to the device 100. The embedded controller 128 and/or the processor 102 may be configured to detect a wake event generated from any of these lower power sensors 126.

At 526, if none of the Bluetooth receiver 126(10), audio microphone 126(2), and ToF sensor 126(9) are available for user presence detection, embedded controller 128 relies on user interactions with the Hall sensor 126(4), keyboard 126(5), mouse 126(6), touchscreen 126(7), or touchpad 126(8) to detect user presence.

If a user is detected at any of 520, 522, 524, or 526, the method 500 moves to 528, where computing device 100 increases the power level, or completely powers ON the device 100. At 530, computing device 100 powers on the display 124 to an operational brightness level. At 532, processor 102 arms the IR camera 126(1) to perform an automatic authentication of the user. The authentication may also be performed in another manner, such as by using a fingerprint reader, or by a manual process of entering a username and password. At 534, the user is seamlessly logged back into the device 100 and the security level is lowered.

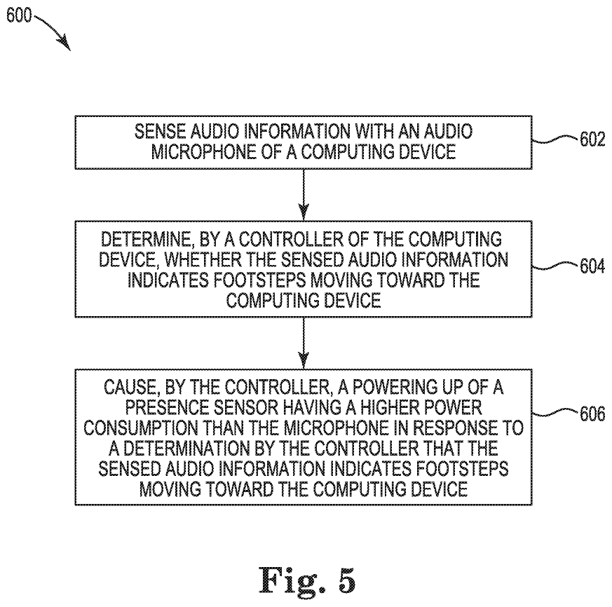

One example of the present disclosure is directed to a method of using audio information for power control of a computing device. FIG. 5 is a flow diagram illustrating a method 600 of using audio information for power control of a computing device according to one example. A non-transitory computer-readable storage medium may store instructions that, when executed by a processor, cause the processor to perform method 600. At 602, the method 600 includes sensing audio information with an audio microphone of a computing device. At 604, the method 600 includes determining, by a controller of the computing device, whether the sensed audio information indicates footsteps moving toward the computing device. At 606, the method 600 includes causing, by the controller, a powering up of a presence sensor having a higher power consumption than the microphone in response to a determination by the controller that the sensed audio information indicates footsteps moving toward the computing device.

The computing device in method 600 may be in a low power state during the sensing of audio information. The method 600 may further include sensing, with the presence sensor, whether a user is present near the computing device; and automatically powering up the computing device in response to the presence sensor sensing that the user is present near the computing device.

The presence sensor in method 600 may include a time of flight (ToF) sensor of the computing device, and the method 600 may further include sensing, with the ToF sensor, whether a user is positioned within sensing range of the ToF sensor. The presence sensor in method 600 may include a Bluetooth receiver of the computing device, and the method 600 may further include receiving, with the Bluetooth receiver, Bluetooth signals from a personal device of a user of the computing device; and determining whether the user is moving toward the computing device based on the received Bluetooth signals. The presence sensor in method 600 may include a camera of the computing device, and the method 600 may further include capturing images with the camera; and processing the captured images to determine whether a user is present near the computing device. The method 600 may further include performing a time-frequency analysis on the sensed audio information to generate a time-frequency map; and wherein the controller determines whether the sensed audio information indicates footsteps moving toward the computing device based on the time-frequency map and a trained model.

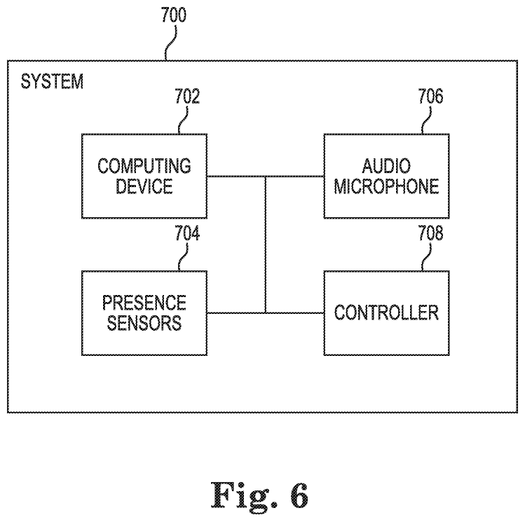

Another example of the present disclosure is directed to a system that uses audio information for power control of a computing device. FIG. 6 is a block diagram illustrating a system 700 that uses audio information for power control of a computing device according to one example. As shown in FIG. 6, system 700 includes a computing device 702, a plurality of presence sensors 704 to detect whether a user is present near the computing device 702, an audio microphone 706 to sense audio information near the computing device 702, and a controller 708 in the computing device 702 to: determine whether the sensed audio information contains information representing footsteps moving toward the computing device; and cause a first one of the presence sensors to power up in response to a determination that the sensed audio information indicates footsteps moving toward the computing device.

The plurality of presence sensors 704 in system 700 may be contained in an ordered list that is ordered based on power consumption of the presence sensors 704. The controller 708 in system 700 may identify the first one of the presence sensors 704 to power up based on the ordered list.

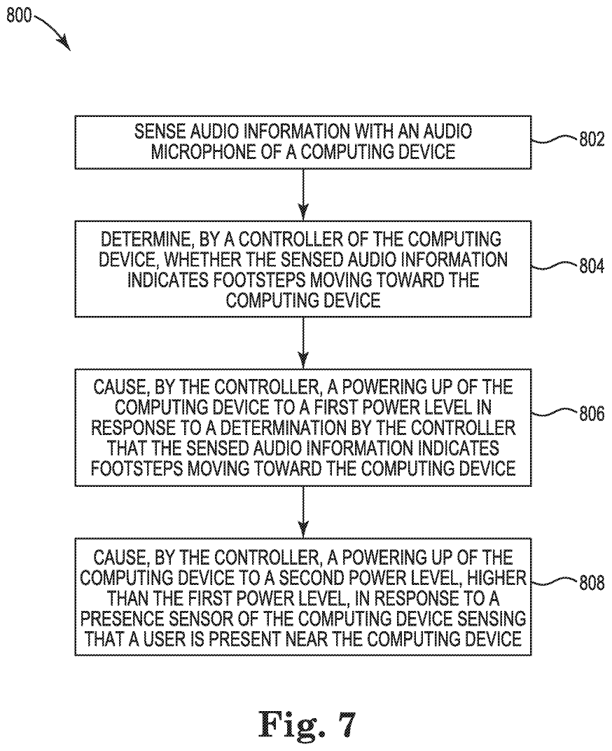

Yet another example of the present disclosure is directed to a method of using audio information for power control of a computing device. FIG. 7 is a flow diagram illustrating a method 800 of using audio information for power control of a computing device according to another example. At 802, the method 800 includes sensing audio information with an audio microphone of a computing device. At 804, the method 800 includes determining, by a controller of the computing device, whether the sensed audio information indicates footsteps moving toward the computing device. At 806, the method includes causing, by the controller, a powering up of the computing device to a first power level in response to a determination by the controller that the sensed audio information indicates footsteps moving toward the computing device. At 808, the method 800 includes causing, by the controller, a powering up of the computing device to a second power level, higher than the first power level, in response to a presence sensor of the computing device sensing that a user is present near the computing device.

The method 800 may further include causing, by the controller, a powering down of the computing device to a third power level, less than the second power level, in response to the presence sensor sensing that the user is no longer present near the computing device.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A non-transitory computer-readable storage medium storing instructions that, when executed by a processor, cause the processor to:
sense audio information with an audio microphone of a computing device;
determine, by a controller of the computing device, whether the sensed audio information indicates footsteps moving toward the computing device; and
cause, by the controller, a powering up of a presence sensor having a higher power consumption than the microphone in response to a determination by the controller that the sensed audio information indicates footsteps moving toward the computing device.

2. The non-transitory computer-readable storage medium of claim 1, wherein the computing device is in a low power state during the sensing of audio information.

3. The non-transitory computer-readable storage medium of claim 2 storing instructions that, when executed by a processor, further cause the processor to:
sense, with the presence sensor, whether a user is present near the computing device; and
automatically power up the computing device in response to the presence sensor sensing that the user is present near the computing device.

4. The non-transitory computer-readable storage medium of claim 1, wherein the presence sensor comprises a time of flight (ToF) sensor of the computing device.

5. The non-transitory computer-readable storage medium of claim 4 storing instructions that, when executed by a processor, further cause the processor to:
sense, with the ToF sensor, whether a user is positioned within sensing range of the ToF sensor.

6. The non-transitory computer-readable storage medium of claim 1, wherein the presence sensor comprises a Bluetooth receiver of the computing device.

7. The non-transitory computer-readable storage medium of claim 6 storing instructions that, when executed by a processor, further cause the processor to:
receive, with the Bluetooth receiver, Bluetooth signals from a personal device of a user of the computing device; and
determine whether the user is moving toward the computing device based on the received Bluetooth signals.

8. The non-transitory computer-readable storage medium of claim 1, wherein the presence sensor comprises a camera of the computing device.

9. The non-transitory computer-readable storage medium of claim 8 storing instructions that, when executed by a processor, further cause the processor to:
capture images with the camera; and
process the captured images to determine whether a user is present near the computing device.

10. The non-transitory computer-readable storage medium of claim 1 storing instructions that, when executed by a processor, further cause the processor to:
perform a time-frequency analysis on the sensed audio information to generate a time-frequency map; and
wherein the controller determines whether the sensed audio information indicates footsteps moving toward the computing device based on the time-frequency map and a trained model.

11. A system comprising:
a computing device;
a plurality of presence sensors to detect whether a user is present near the computing device;
an audio microphone to sense audio information near the computing device; and
a controller in the computing device to:
determine whether the sensed audio information contains information representing footsteps moving toward the computing device; and
cause a first one of the presence sensors to power up in response to a determination that the sensed audio information indicates footsteps moving toward the computing device.

12. The system of claim 11, wherein the plurality of presence sensors are contained in an ordered list that is ordered based on power consumption of the presence sensors.

13. The system of claim 12, wherein the controller identifies the first one of the presence sensors to power up based on the ordered list.

14. A method, comprising:
sensing audio information with an audio microphone of a computing device;
determining, by a controller of the computing device, whether the sensed audio information indicates footsteps moving toward the computing device; and
causing, by the controller, a powering up of the computing device to a first power level in response to a determination by the controller that the sensed audio information indicates footsteps moving toward the computing device; and
causing, by the controller, a powering up of the computing device to a second power level, higher than the first power level, in response to a presence sensor of the computing device sensing that a user is present near the computing device.

15. The method of claim 14, and further comprising:
causing, by the controller, a powering down of the computing device to a third power level, less than the second power level, in response to the presence sensor sensing that the user is no longer present near the computing device.
